(19) United States
(12) Patent Application Publication
(10) Pub. No.: US 2023/0422200 A1
(43) Pub. Date: Dec. 28, 2023

(54) UE-TO-UE POSITIONING

(71) Applicant: QUALCOMM Incorporated, San Diego, CA (US)

(72) Inventors: Jingchao BAO, San Diego, CA (US); Sony AKKARAKARAN, Poway, CA (US); Alexandros MANOLAKOS, Escondido, CA (US); Tao LUO, San Diego, CA (US)

(21) Appl. No.: 18/251,258

(22) PCT Filed: Dec. 3, 2021
(86) PCT No.: PCT/US2021/061801

§ 371 Date: May 1, 2023

(30) Foreign Application Priority Data
Dec. 9, 2020 (GR) 20200100719

(51) Int. Cl. H04W 64/00

(52) U.S. Cl. CPC H04W 64/00

(57) ABSTRACT

A method for using a first UE as an anchor point includes: sending, from the first UE to a network entity, a positioning capability message indicating that the first UE is capable of transferring a PRS between the first UE and a second UE; where the method further includes: sending, from the first UE to the second UE, a first PRS; or measuring, at the first UE, a second PRS received from the second UE; or a combination thereof.

### CROSS-REFERENCE TO RELATED APPLICATIONS

This application claims the benefit of Greek Patent Application No. 20200100719, filed Dec. 9, 2020, entitled “UE-TO-UE POSITIONING,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard.

Furthermore, signaling efficiencies should be enhanced and latency should be substantially reduced compared to current standards.

### SUMMARY

In an embodiment, a first UE (user equipment) includes: a wireless interface; a memory; and a processor communicatively coupled to the wireless interface and the memory; where the processor is configured to send, via the wireless interface to a network entity, a positioning capability message indicating that the first UE is capable of transferring a PRS (positioning reference signal) between the first UE and a second UE; and where: the processor is configured to send, via the wireless interface to the second UE, a first PRS; or the processor is configured to measure a second PRS received via the wireless interface from the second UE; or a combination thereof.

Implementations of such a first UE may include one or more of the following features. The positioning capability message further indicates that the first UE is configured to imitate a transmission/reception point (TRP) for sending the first PRS to the second UE or measuring the second PRS from the second UE or a combination thereof. The processor is further configured to send, to the network entity, an expected reference signal time difference, or an expected reference signal time difference uncertainty, or one or more quasi co-location parameters, or any combination thereof.

Also or alternatively, implementations of such a first UE may include one or more of the following features. The processor is configured to send the positioning capability message to the network entity in response to a request received from the network entity for whether the first UE is capable of serving as an anchor point for positioning of the second UE. The processor is further configured to send, to the second UE: a real time difference, or a location of the first UE, or a location uncertainty of the location of the first UE, or a beam angle provided by the first UE, or a beam shape provided by the first UE, or a mobility status of the first UE, or any combination thereof. The processor is configured to send the first PRS with the first PRS including a first sidelink PRS, or the processor is configured to measure the second PRS with the second PRS including a second sidelink PRS, or a combination thereof. The wireless interface and the processor are further configured to receive and measure the second PRS, the second PRS including an uplink PRS. The processor is further configured to send a positioning measurement report to the network entity via the wireless interface using a protocol used by transmission/reception points for sending positioning measurement reports to the network entity. The processor is further configured to send a TRP ID (transmission/reception point identity) or a cell ID, or a combination thereof, to the second UE in the positioning measurement report.

Also or alternatively, implementations of such a first UE may include one or more of the following features. The processor is configured to process, absent a measurement gap at the first UE during reception of the second PRS, only a portion of the second PRS within a downlink bandwidth part of the first UE. The processor is configured to process, in response to the second PRS coinciding with a measurement gap at the first UE, all of the second PRS.

In an embodiment, a method for using a first UE as an anchor point includes: sending, from the first UE to a network entity, a positioning capability message indicating that the first UE is capable of transferring a PRS between the first UE and a second UE; where the method further includes: sending, from the first UE to the second UE, a first PRS; or measuring, at the first UE, a second PRS received from the second UE; or a combination thereof.

Implementations of such a method may include one or more of the following features. The positioning capability message indicates that the first UE is configured to imitate a TRP for sending the first PRS to the second UE or measuring the second PRS from the second UE or a combination thereof. The method further includes sending, to the network entity, an expected reference signal time difference, or an expected reference signal time difference uncertainty, or one or more quasi co-location parameters, or any combination thereof.

Also or alternatively, implementations of such a method may include one or more of the following features. The positioning capability message is sent to the network entity in response to a request received from the network entity for whether the first UE is capable of serving as the anchor point for positioning of the second UE. The method further includes sending, from the first UE to the second UE: a real time difference, or a location of the first UE, or a location uncertainty of the location of the first UE, or a beam angle provided by the first UE, or a beam shape provided by the first UE, or a mobility status of the first UE, or any combination thereof. The method includes: sending, from the first UE to the second UE, the first PRS with the first PRS including a first sidelink PRS; or measuring, at the first UE, the second PRS with the second PRS including a second sidelink PRS; or a combination thereof. The method includes measuring, at the first UE, the second PRS, where the second PRS includes an uplink PRS. The method further includes sending, from the first UE, a positioning measurement report to the network entity using a protocol used by transmission/reception points for sending positioning measurement reports to the network entity. The positioning measurement report includes a TRP ID or a cell ID or a combination thereof.

Also or alternatively, implementations of such a method may include one or more of the following features. The method includes measuring the second PRS, where measuring the second PRS includes measuring only a portion of the second PRS within a downlink bandwidth part of the first UE absent a measurement gap at the first UE during reception of the second PRS. The method includes measuring the second PRS, where measuring the second PRS includes measuring all of the second PRS in response to the second PRS coinciding with a measurement gap at the first UE.

In an embodiment, another first UE includes: second sending means for sending, to a network entity, a positioning capability message indicating that the first UE is capable of transferring a PRS between the first UE and a second UE; and where the first UE further includes: first sending means for sending, to the second UE, a first PRS; or means for measuring a second PRS received from the second UE; or a combination thereof.

Implementations of such a first UE may include one or more of the following features. The positioning capability message indicates that the first UE is configured to imitate a TRP for sending the first PRS to the second UE or measuring the second PRS from the second UE or a combination thereof. The second sending means includes means for sending, to the network entity, an expected reference signal time difference, or an expected reference signal time difference uncertainty, or one or more quasi co-location parameters, or any combination thereof.

Also or alternatively, implementations of such a first UE may include one or more of the following features. The second sending means includes means for sending the positioning capability message to the network entity in response to a request received from the network entity for whether the first UE is capable of serving as an anchor point for positioning of the second UE. The first UE further includes third sending means for sending, to the second UE: a real time difference, or a location of the first UE, or a location uncertainty of the location of the first UE, or a beam angle provided by the first UE, or a beam shape provided by the first UE, or a mobility status of the first UE, or any combination thereof. The first UE includes the first sending means, where the first PRS includes a first sidelink PRS, or the first UE includes the means for measuring the second PRS, where the second PRS includes a second sidelink PRS, or a combination thereof. The first UE includes the means for measuring the second PRS, where the second PRS includes an uplink PRS. The first UE further includes means for sending a positioning measurement report to the network entity using a protocol used by transmission/reception points for sending positioning measurement reports to the network entity. The positioning measurement report includes a TRP ID or a cell ID or a combination thereof.

Also or alternatively, implementations of such a first UE may include one or more of the following features. The first UE includes the means for measuring the second PRS, where the means for measuring the second PRS includes means for measuring only a portion of the second PRS within a downlink bandwidth part of the first UE absent a measurement gap at the first UE during reception of the second PRS. The first UE includes the means for measuring the second PRS, where the means for measuring the second PRS includes means for measuring all of the second PRS in response to the second PRS coinciding with a measurement gap at the first UE.

In an embodiment, a non-transitory, processor-readable storage medium including processor-readable instructions to cause a processor, of a first UE, to: send, to a network entity, a positioning capability message indicating that the first UE is capable of transferring a PRS between the first UE and a second UE; where the non-transitory, processor-readable storage medium further includes: processor-readable instructions to cause the processor to send, to the second UE, a first PRS; or processor-readable instructions to cause the processor to measure a second PRS received from the second UE; or a combination thereof.

Implementations of such a storage medium may include one or more of the following features. The positioning capability message indicates that the first UE is configured to imitate a TRP for sending the first PRS to the second UE or measuring the second PRS from the second UE or a combination thereof. The non-transitory, processor-readable storage medium further includes processor-readable instructions to cause the processor to send, to the network entity, an expected reference signal time difference, or an expected reference signal time difference uncertainty, or one or more quasi co-location parameters, or any combination thereof.

Also or alternatively, implementations of such a storage medium may include one or more of the following features. The processor-readable instructions to cause the processor to send the positioning capability message include processor-readable instructions to cause the processor to send the positioning capability message to the network entity in response to a request received from the network entity for whether the first UE is capable of serving as the anchor point for positioning of the second UE. The non-transitory, processor-readable storage medium further includes processor-readable instructions to cause the processor to send, to the second UE: a real time difference, or a location of the first UE, or a location uncertainty of the location of the first UE, or a beam angle provided by the first UE, or a beam shape provided by the first UE, or a mobility status of the first UE, or any combination thereof. The non-transitory, processor-readable storage medium includes: the processor-readable instructions to cause the processor to send the first PRS, where the first PRS includes a first sidelink PRS: or the processor-readable instructions to cause the processor to measure the second PRS, where the second PRS includes a second sidelink PRS; or a combination thereof. The non-transitory, processor-readable storage medium includes the processor-readable instructions to cause the processor to measure the second PRS, where the second PRS includes an uplink PRS. The non-transitory, processor-readable storage medium further includes processor-readable instructions to cause the processor to send a positioning measurement report to the network entity using a protocol used by transmission/reception points for sending positioning measurement reports to the network entity. The positioning measurement report includes a TRP ID or a cell ID or a combination thereof.

Also or alternatively, implementations of such a storage medium may include one or more of the following features. The non-transitory, processor-readable storage medium includes the processor-readable instructions to cause the processor to measure the second PRS, where the processor-readable instructions to cause the processor to measure the second PRS include processor-readable instructions to cause the processor to measure only a portion of the second PRS within a downlink bandwidth part of the first UE absent a measurement gap at the first UE during reception of the second PRS. The non-transitory, processor-readable storage medium includes the processor-readable instructions to cause the processor to measure the second PRS, where the processor-readable instructions to cause the processor to measure the second PRS include processor-readable instructions to cause the processor to measure all of the second PRS in response to the second PRS coinciding with a measurement gap at the first UE.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a simplified perspective view of a positioning system.

FIG. 6 is a block diagram of a user equipment.

FIG. 7 is a processing and signal flow for determining position information.

FIG. 8 is an example of a capability message shown in FIG. 7.

FIG. 9 is a simplified diagram of signal chains of the user equipment shown in FIG. 6.

FIG. 10 is a block flow diagram of a method for facilitating use of a user equipment as an anchor point.

### DETAILED DESCRIPTION

Techniques are discussed herein for using a user equipment (an anchor UE) for signal transfer with another user equipment (a target UE). The anchor UE may serve as an anchor point for positioning with the target UE, e.g., to send and/or receive reference signals to and/or from the target UE for measurement and use in determining a location of the target UE. The anchor UE may send one or more capability messages (e.g., in response to a request to be an anchor point) indicating the capability of the anchor UE to serve as an anchor point. The capability message(s) may provide further specifics as to the abilities of the anchor UE, e.g., regarding types of signaling and/or positioning techniques supported by the anchor UE. The anchor UE may be able to emulate a base station, e.g., transmitting signals to and/or receiving signals from a location management function and/or the target UE similarly to how a base station would transmit and/or receive signals (e.g., using a protocol that a base station would use, providing information (e.g., base station ID (identity)), etc.). These techniques are examples, and other examples may be implemented.

Items and/or techniques described herein may provide one or more of the following capabilities, and possibly one or more other capabilities not mentioned. Positioning of a target UE may be achieved in the absence of sufficient base stations for positioning of the target UE. Positioning accuracy of a target UE may be improved. Communication from a target UE may be improved, e.g., by using an anchor UE as a communication relay. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

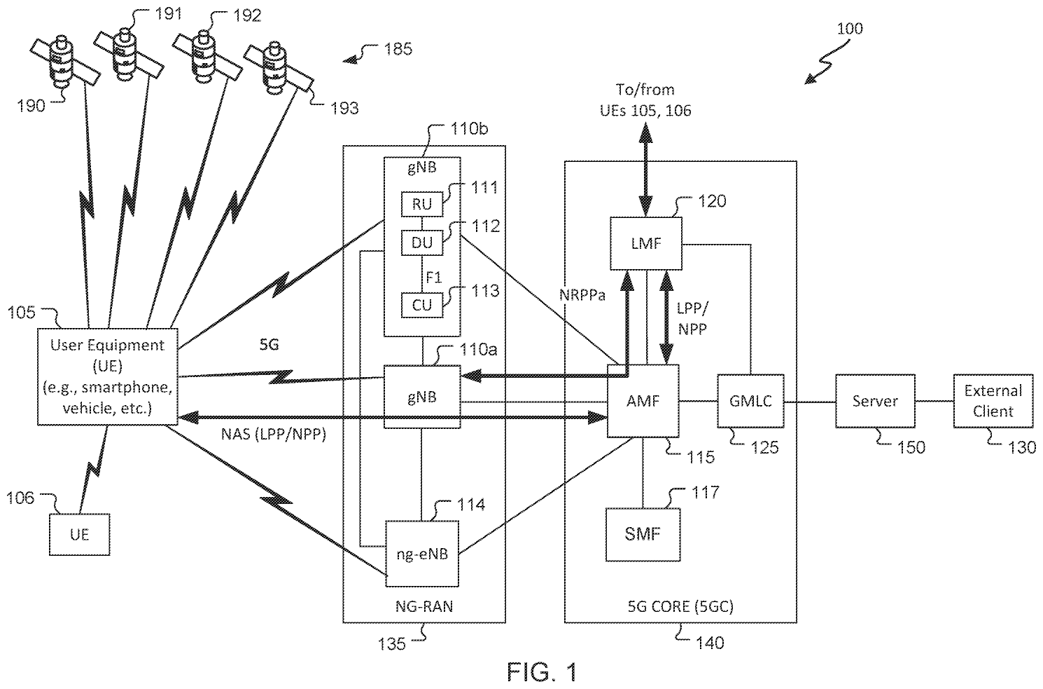

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more BSs, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs I 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

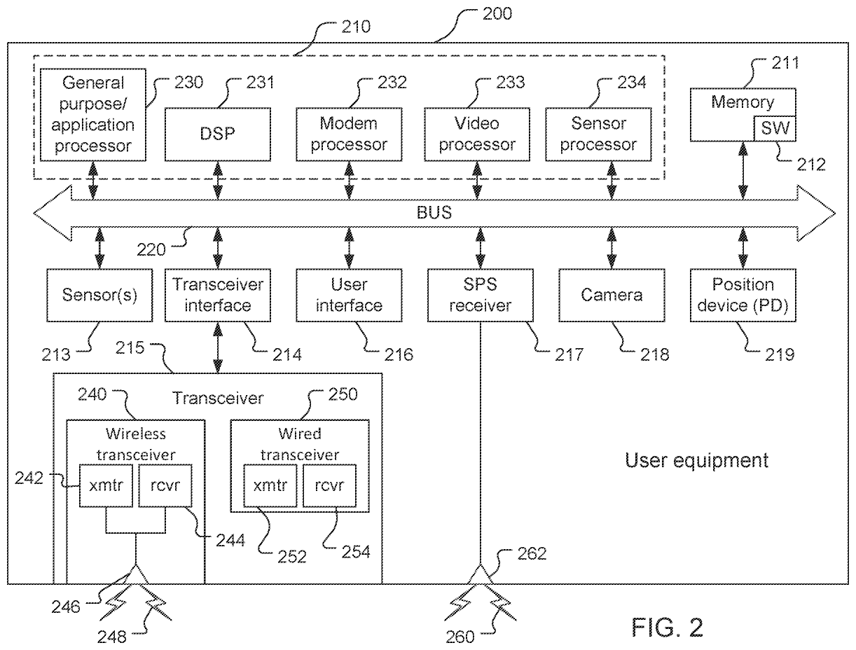

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

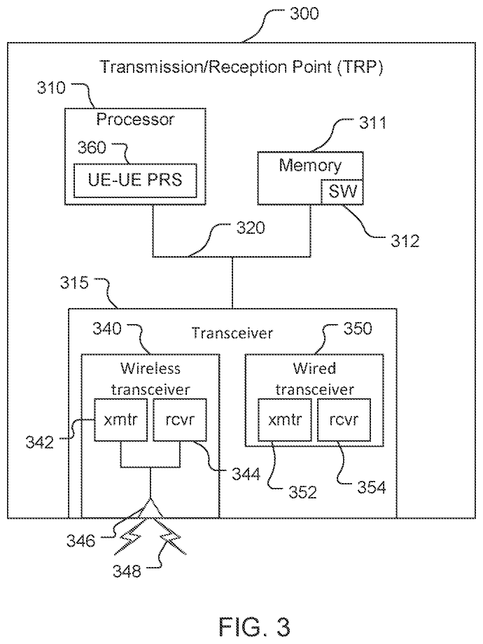

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless interface) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below. The processor 310 (possibly in conjunction with the memory 311 and, as appropriate, the transceiver 315) includes a UE-UE PRS unit 360. The UE-UE PRS unit 360 may be configured to send a PRS configuration message to a target UE with a PRS schedule and PRS configuration parameters. The configuration and functionality of the UE-UE unit PRS 360 is discussed further herein.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

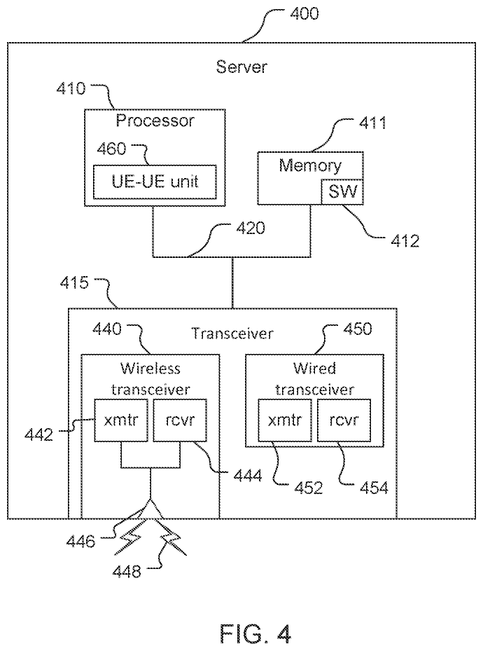

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions.

The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below. The processor 410 (possibly in conjunction with the memory 411 and, as appropriate, the transceiver 415) includes a UE-UE unit 460. The UE-UE unit 460 may be configured to send anchor requests to one or more TRPs, send emulation messages to one or more anchor UEs, and send assistance data to one or more TRPs. The configuration and functionality of the UE-UE unit 460 is discussed further herein.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response.

By comparing the difference T_{Tx,Rx} between the transmission time of the RTT measurement signal from the base station and the ToA of the RTT response at the base station to the UE-reported time difference T_{Rx,Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS ((Channel State Information—Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nd resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

UE-to-UE Positioning

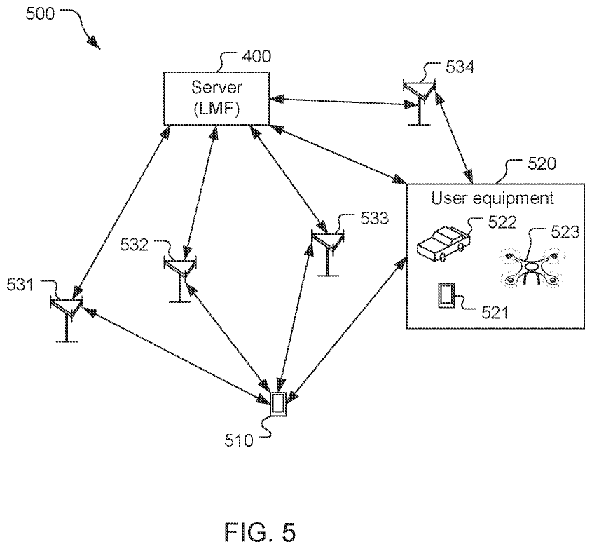

Referring to FIG. 5, with further reference to FIGS. 1-4, a positioning system 500 includes a target UE 510, an anchor UE 520, TRPs 531, 532, 533, 534 (e.g., gNBs), and a server 400 (e.g., an LMF). Each of the TRPs 531-534 may be an example of the TRP 300. Each of the UEs 510, 520 may be an example of the UE 200, and may take any of a variety of forms. For example, the target UE 510 is shown as a smartphone, but other forms of UEs may be used. Further, the anchor UE 520 is shown as possibly being a smartphone 521, or a vehicle 522, or an unoccupied aerial vehicle (UAV) 523 (e.g., a drone), although other forms of UEs may be used. The anchor UE 520 may, for example, have more processing power and/or faster processing speed than a smartphone typically has. The target UE 510 may be configured to send and/or receive reference signals to and/or from the TRPs 531-533 to help determine a position of the target UE 510, e.g., by measuring reference signals from one or more of the TRPs 531-533 and/or providing reference signals (e.g., SRS for positioning, also called UL-PRS) to the TRPs 531-533 for measurement. The TRPs 531-533 within communication range of the target UE 510 may provide insufficient anchor points for determining a location of the target UE 510, or determining the location of the target UE 510 with desired accuracy. Consequently, it may be desirable to be able to use one or more other UEs, e.g., the anchor UE 520, as an anchor point to which to transmit one or more reference signals and/or from which to receive one or more reference signals for determining the position of the target UE 510, or for helping to determine the position of the target UE 510 (e.g., add to other measurements for determining the position of the target UE 510).

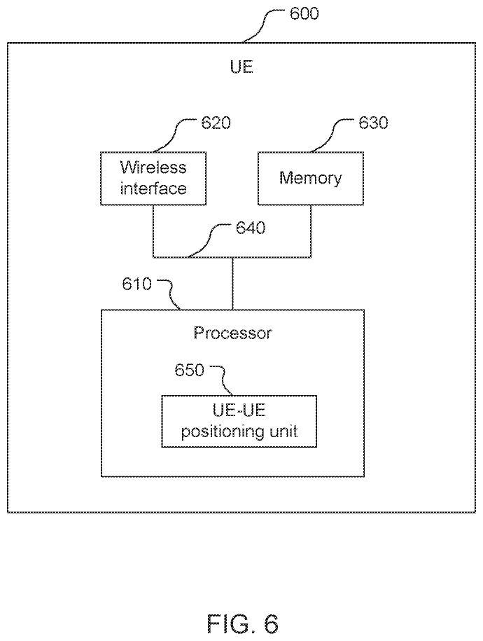

Referring to FIG. 6, with further reference to FIGS. 1-5, a UE 600, of which the anchor UE 520 shown in FIG. 5 is an example, includes a processor 610, a wireless interface 620, and a memory 630 communicatively coupled to each other by a bus 640. The UE 600 may include some or all of the components shown in FIG. 6, and may include one or more other components such as any of those shown in FIG. 2 such that the UE 200 may be an example of the UE 600. The processor 610 may include one or more components of the processor 210. The wireless interface 620 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. The UE 600 may also include a wired interface such as the wired transmitter 252 and/or the wired receiver 254. The wireless interface 620 may include the SPS receiver 217 and the SPS antenna 262. The memory 630 may be configured similarly to the memory 211, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the UE 600 performing a function as shorthand for one or more appropriate components (e.g., the processor 610 and the memory 630) of the UE 600 performing the function. The processor 610 (possibly in conjunction with the memory 630 and, as appropriate, the wireless interface 620) includes a UE-UE positioning unit 650. The UE-UE positioning unit 650 may be configured to send one or more capability messages indicating an ability of the UE 600 to serve as an anchor point for use in determining a position of a target UE, e.g., the target UE 510. The capability message(s) may indicate one or more modes of operation of the UE 600, e.g., to act as a TRP anchor point (which may be called a transparent mode or a base-station mode) or to act as a UE anchor point (which may be called an advanced mode or a UE-anchor mode). The UE-UE positioning unit 650 may cause the UE 600 to operate in the transparent or advanced modes to assist with determining position of the target UE. The configuration and functionality of the UE-UE positioning unit 650 is discussed further herein.

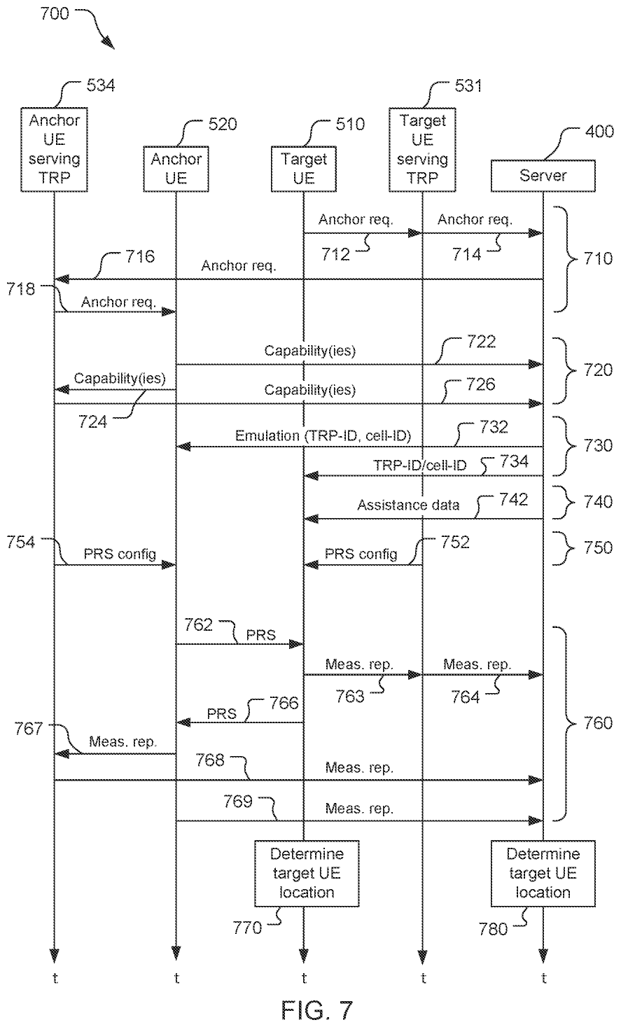

Referring also to FIG. 7, a processing and signal flow 700 for determining position information includes the stages shown. The flow 700 is an example, and stages may be added to, removed from, and/or rearranged in the flow 700.

At stage 710, a request for a UE to serve as an anchor point for positioning of a target UE, here the target UE 510, is sent to an anchor UE, here the anchor UE 520. For example, the target UE 510 may send an anchor request 712 to the TRP 531, that is a serving TRP for the target UE 510, and the TRP 531 may send an anchor request 714 to the server 400. The anchor request 712 may explicitly request one or more anchor points in addition to any TRPs 300 that are visible to the target UE 510. Also or alternatively, the anchor request 712 may implicitly request one or more anchor points. For example, the anchor request 712 may request a location of the target UE 510, and the server 400 may determine that the target UE 510 does not have sufficient TRPs 300 visible in order to determine a location of the target UE 510. As another example, the anchor request 712 may request a location of the target UE 510 with a specified level of accuracy and indicate of a quantity of TRPs 300 visible to the target UE 510, where the quantity of visible TRPs 300 is insufficient for positioning of the target UE 510 with at least the indicated accuracy. Still other implicit requests for one or more anchor points, e.g., additional anchor points, are possible. In response to the anchor request 714, the server 400, e.g., the UE-UE unit 460, may send an anchor request 716 to one or more TRPs 300, including to the TRP 534 that is the serving TRP for the anchor UE 520. The server 400 may, for example, send the anchor request 716 to any TRP 300 whose coverage area borders a coverage area of a TRP visible to the target UE 510, and/or that includes or borders a last-known location for the target UE 510, and/or that includes a home location TRP for the target UE 510. The TRP 534 may respond to receiving the anchor request 716 by sending an anchor request 718 to the anchor UE 520. The TRP 534 may broadcast the anchor request 718 as a broadcast message, or may send the anchor request 718 unicast as a point-to-point message. The anchor request 718 may request the anchor UE 520 (and possibly other UEs) to serve as an anchor point. The anchor request 718 may include an explicit or implicit request that a UE that is able and willing to serve as an anchor point respond to the anchor request 718, e.g., indicating the ability and willingness to be an anchor point. The anchor requests 716, 718 may request for the anchor UE 520 to indicate one or more specified capabilities (rather than being a general request), e.g., for specific signaling and/or positioning technique support.

At stage 720, the anchor UE 520 sends a capability message 722 to the server 400 and/or sends a capability message 724 to the TRP 534 to which the TRP 534 responds by sending a capability message 726 to the server 400. The UE-UE positioning unit 650 may be configured to provide the capability messages 722, 724, via the wireless interface 620, in response to receiving the anchor request 718, and/or regardless of whether the anchor request 718 is received (e.g., periodically, semi-periodically, aperiodically, and/or on-demand), e.g., in response to receiving an anchor request from the target UE 510. The UE-UE positioning unit 650 may be configured to provide the capability messages 722, 724 to indicate that the UE 600, here the anchor UE 520, has the ability and is willing to serve as an anchor point for positioning of the target UE 510. The UE-UE positioning unit 650 may be configured to send, via the wireless interface 620 to a network entity (e.g., the TRP 300, here the TRP 534, and/or the server 400 (e.g., an LMF)) an indication that the UE 600 is capable of sending a reference signal to, and/or of receiving and measuring a reference signal from, a target UE for determining a position of the target UE. The UE-UE positioning unit 650 may be configured to determine whether the UE 600 has available resources, e.g., battery power, for serving as an anchor point in addition to having the ability (e.g., being configured) to serve as an anchor point. The UE-UE positioning unit 650 may be configured to inform the network entity that the UE 600 may emulate a TRP (in a transparent or base-station mode) or may serve as a UE anchor point (in an advanced or UE-anchor mode), and may provide indications of one or more other capabilities, e.g., e.g., one or more supported positioning techniques, signal provision and/or signal measurement capabilities, etc. The anchor UE 520 may be configured to send the capability message 722 directly to the server 400 using LPP signaling. The anchor UE 520 may be configured to send the capability message 724 to the TRP 534 using UCI (Uplink Control Information) or MAC-CE signaling, and the TRP 534 may send the capability message 726 to the server 400 using NRPPa signaling in a backhaul connection.

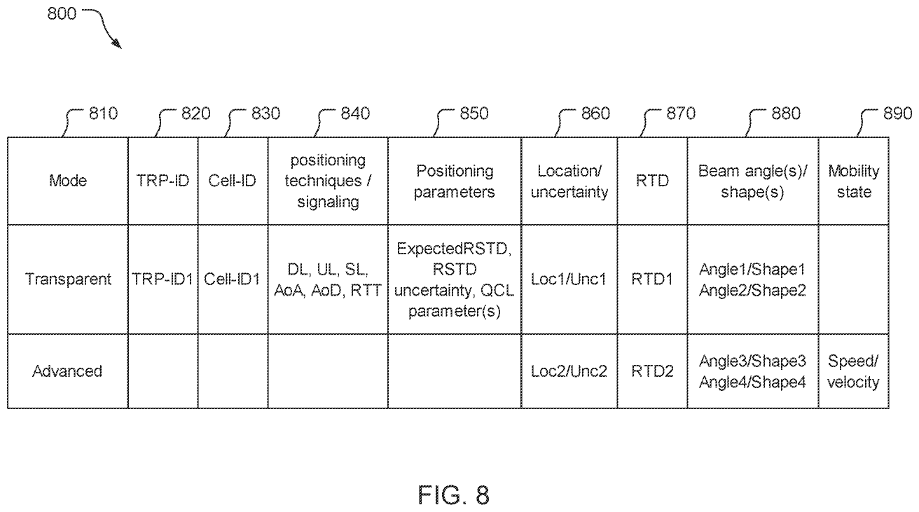

Referring also to FIG. 8, the UE-UE positioning unit 650 may be configured to provide a capability message 800 to the server 400 as the capability message 722 and/or to the TRP 534 as the capability message 724. The capability message 800 includes a mode field 810, a TRP-ID field 820, a cell-ID field 830, a positioning techniques/signaling field 840, a positioning parameters field 850, a location/uncertainty field 860, an RTD field 870, a beam angle(s)/shape(s) field 880, and a mobility state field 890. The mode field 810 indicates in which operating mode(s) the anchor UE 520 is configured to operate to serve as an anchor point. The capability message 800 may indicate that the anchor UE 520 may operate in the transparent (base-station) mode and/or the advanced (UE-anchor) mode. One or more of the fields 810, 820, 830, 840, 850, 860, 870, 880, 890 may be omitted. For example, the fields 820, 830, 840, 850 may be omitted if the mode field 810 indicates only the advanced mode (and not the transparent mode), and the field 890 may be omitted, e.g., if the mode field 810 indicates only the transparent mode. The field 810 may be omitted, e.g., with the provision of information in fields 820, 830, 840, 850 implicitly indicating that the anchor UE 520 is capable of transparent mode operation or the provision of information in the mobility state field 890 implicitly indicating that the anchor UE 520 is capable of advanced mode operation. The location/uncertainty field 860 may be omitted, e.g., if the corresponding information is unavailable. Thus, the location of the anchor UE 520 may not be known before informing the server 400 of the ability (and willingness) of the anchor UE 520 to serve as an anchor point.

The TRP-ID field 820 may indicate a proposed TRP-ID for the anchor UE 520 to use to emulate a TRP. The value of the TRP-ID field 820 may be the proposed TRP-ID or may be a coded value indicative of the proposed TRP-ID, e.g., of several possible TRP-IDs stored in the memory 630 that the server 400 also knows and thus may equate with the coded value. Also or alternatively, as discussed further below, the TRP-ID to be used by the anchor UE 520 may be sent to the anchor UE 520, e.g., from the server 400 (e.g., via the TRP 534).

The cell-ID field 830 may indicate a proposed cell-ID for the anchor UE 520 to use to emulate a TRP. The value of the cell-ID field 830 may be the proposed cell-ID or may be a coded value indicative of the proposed cell-ID, e.g., of several possible cell-IDs stored in the memory 630 that the server 400 also knows and thus may equate with the coded value. Also or alternatively, as discussed further below, the cell-ID to be used by the anchor UE 520 may be sent to the anchor UE 520, e.g., from the server 400 (e.g., via the TRP 534).

The positioning techniques/signaling field 840 may indicate one or more positioning techniques and/or one or more signaling schemes supported by the anchor UE 520. For example, as shown, the positioning techniques/signaling field 840 indicates that in the transparent mode the anchor UE 520 is capable of processing PRS for DL-based positioning, UL-based positioning, and SL-based positioning. The positioning techniques/signaling field 840, in this example, indicates that in the transparent mode the anchor UE 520 is capable of AoA-based positioning and AoD-based positioning, e.g., to determine an AoA of a received reference signal and to provide AoD for transmitted PRS by the anchor UE 520. The positioning techniques/signaling field 840, in this example, indicates that in the transparent mode the anchor UE 520 is capable of RTT-based positioning (e.g., determining Rx-Tx time difference). Still other positioning techniques and/or signaling capabilities may be indicated.

The positioning parameters field 850 indicates one or more other parameters for the anchor UE 520 to emulate a TRP. In the example shown, the positioning parameters field 850 provides values for expected RSTD, RSTD uncertainty, and one or more QCL parameters (e.g., QCL type, antenna beam(s)). The QCL parameter(s) may be provided for the target UE 510 to determine to use a particular antenna beam to measure a particular PRS (e.g., to use a beam to receive a DL PRS where that beam received an SSB signal well and the QCL parameters indicate that the DL PRS is QCLed with the SSB signal).

The location/uncertainty field 860 may include one or more forms of location of the anchor UE 520. For example, the location/uncertainty field 860 may indicate latitude and longitude of the anchor UE 520, and may indicate a time at which the location was determined. The location/uncertainty field 860 may indicate an uncertainty in the corresponding indicated location, e.g., a radius, a latitude window (range) and a longitude window (range), etc.

The fields 870, 880 provide information useful in the transparent and advanced modes of operation. The RTD field 870 indicates a real time difference (RTD) value at the anchor UE 520 (a difference between transmission times of reference signals from bases stations used to determine an RSTD). The beam angle(s)/shape(s) field 880 may provide information as to one or more beam angles of one or more antennas and/or one or more antenna panels of the anchor UE 520 and the corresponding shape(s) of the beam(s). The beam angle reported may be at boresight and provided in terms of an azimuth angle (and possibly a zenith angle) in a global or local coordinate system. Also or alternatively, the beam angle may be reported as an angle relative to a body of the anchor UE 520 and the orientation of the anchor UE 520 relative to the Earth (in a global coordinate system) also reported. For beam shape, a beamwidth and/or an antenna configuration may be provided that define a beam shape.

The mobility state field 890 may indicate a speed (and possibly velocity) of the anchor UE 520. For example, the mobility state field 890 may indicate that the anchor UE 520 is static, and may indicate a length of time that the anchor UE 520 has been static. The mobility state field 890 may include a variety of information indicative of a reliability of a location of the anchor UE 520. The server 400 may select which UE(s) to use as anchor points based on one or more factors such as reliability of location of the UE, e.g., based on the location uncertainty and/or the mobility status (e.g., UE speed).

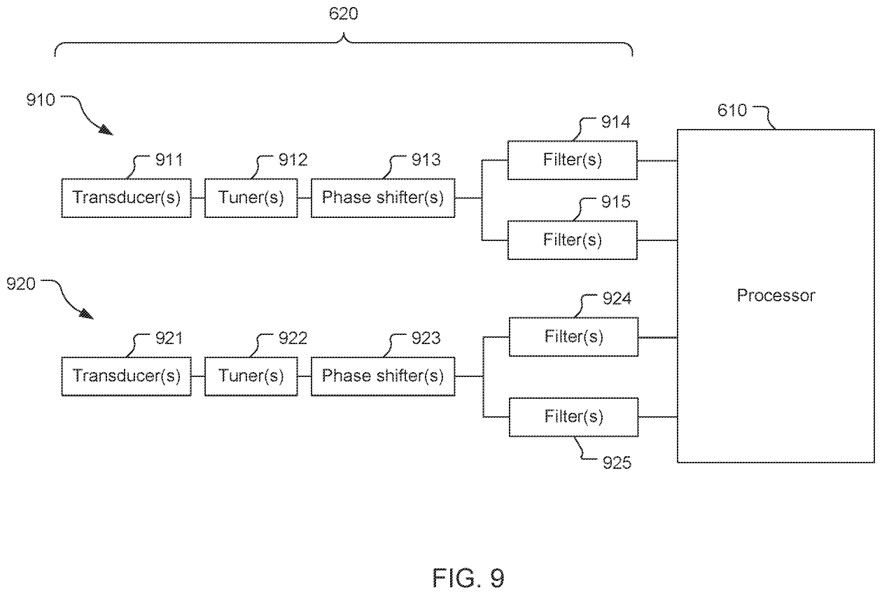

Referring also to FIG. 9, the UE 600 may be configured to steer one or more beams and to tune one or more receive chains for particular signals (e.g., frequencies of signals). The wireless interface 620 may include multiple signal paths 910, 920 that each respectively include one or more transducers 911, 921, that may be coupled to one or more respective tuners 912, 922, that may be coupled to one or more respective phase shifters 913, 923, that may be coupled to one or more filters 914, 915 and one or more filters 924, 925 to receive one or more signals from one or more desired AoAs and to provide the signal(s) to the processor 610, e.g., for measurement. The signal paths 910, 920 may be receive-signal paths and/or transmit-signal paths. The tuner(s) 912, the phase shifter(s) 913, and the filter(s) 914, 915 provide two signal chains. The tuner(s) 912, 922 (e.g., impedance tuner(s)), the phase shifter(s) 913, 923, and the filter(s) 914, 915, 924, 925 are optional, and any one or more of these items may be omitted. The transducer(s) 911, 921 may comprise one or more antennas disposed on one or more antenna panels. The tuner(s) 911, 921 may be adjusted under the control of the processor 610 such that the transducer(s) 911, 921 are tuned to receive different frequencies (e.g., signals of different frequency bands). The phase shifter(s) 912, 922 may be controlled by the processor 610 to provide different phase shifts to the transducer(s) 911, 921 to steer a beam of the transducer(s) 911, 921. The filter(s) 914, 915, 924, 925 may be configured to block or allow desired signal frequencies, and may be controlled by the processor 610 to change what frequencies are blocked/passed. One of more of the signal paths 910, 920 may be changed to receive or transmit different frequencies and/or different angles of arrival/departure of signals at different times, e.g., by varying phase shifts and/or frequency filters applied to the signals. The signal paths 910, 920 shown are examples, and other configurations are possible.

Referring again to FIG. 7, at stage 730, the server 400 (e.g., the UE-UE unit 460) may send an emulation message 732 to the anchor UE 520. Although the emulation message 732 is shown being sent directly to the anchor UE 520, the emulation message 732 may be sent to the anchor UE 520 via the TRP 534 (i.e., the serving TRP for the anchor UE 520). The emulation message 732 may include a TRP-ID and/or a cell-ID to be used by the anchor UE 520 to emulate a TRP (e.g., to serve other UEs and/or for inclusion in PRS reports (e.g., for RTT), e.g., a measurement report 769 discussed below). The TRP-ID and/or the cell-ID for the anchor UE 520 to emulate a TRP is also sent from the server 400 to the target UE 510 in a TRP-ID/cell-ID message 734. The emulation message 732 may be omitted, e.g., if the server 400 does not provide a TRP-ID and/or a cell-ID to the anchor UE 520, e.g., override indications from the server 400 of the TRP-ID and/or cell-ID to be used by the anchor UE 520. The emulation message 732 may include a TRP-ID and/or a cell-ID, e.g., including a confirmation of a TRP-ID and/or a confirmation of a cell-ID provided by the anchor UE 520 in the capability message 722, 724. The TRP-ID and/or cell-ID may be provided to the anchor UE 520 as assistance data and may be provided using LPP signaling (e.g., NRPPa signaling inside LPP signaling).

At stage 740, the server 400 (e.g., the UE-UE unit 460) may send an assistance data message 742 to the target UE 510. Although the assistance data message 742 is shown being sent directly to the target UE 510, the assistance data message 742 may be sent to the target UE 510 via the TRP 531 (i.e., the serving TRP for the target UE 510). The assistance data in the assistance data message 742 may include information regarding the anchor UE 520 to facilitate the anchor UE 520 emulating a TRP. For example, the assistance data message 742 may include some or all of the information of the fields 820, 830, 840, 850, 860, 870, 880 of the capability message 800, whether the server 400 obtained this information from the capability message 800 or from another source. The target UE 510 may use the TRP-ID and/or the cell-ID information to report measurements of PRS along with the TRP-ID and/or the cell-ID such that the measurements can be associated with the PRS source, i.e., the anchor UE 520 and a corresponding location of the anchor UE 520. For example, a measurement report from the target UE 510 regarding PRS received from the anchor UE 520 may include the TRP-ID of the anchor UE 520. The assistance data message 742 may include a position (location) of the anchor UE 520, e.g., if included in the capability message 800 and if UE-based positioning is to be implemented, where the target UE 510 will determine the location of the target UE 510. The assistance data message 742 may be sent from the server 400 to the target UE 510 using LPP. As the information in the fields 860, 870, 880 may change dynamically, the assistance data of the fields 860, 870, 880 may be sent to the target UE 510 using LMF-in-RAN signaling using layer 1 and/or layer 2 (physical layer and/or MAC layer) signaling that have lower latency than higher-layer signaling.

At stage 750, PRS configuration information is provided to the target UE 510, and to the anchor UE 520 as appropriate. For example, the TRP 531 (e.g., a UE-UE PRS unit 360 of the TRP 531) may send a PRS configuration message 752 to the target UE 510 with a PRS schedule and PRS configuration parameters (e.g., offset, comb number, frequency layer, etc.) for receiving PRS from the anchor UE 520 and/or for sending PRS to the anchor UE 520. The TRP 534 may send a PRS configuration message 754 with PRS configuration information for receiving PRS from the target UE 510 and/or for sending PRS to the target UE 510.

At stage 760, the anchor UE 520 may send PRS to the target UE 510, that measures the received PRS and reports the measurement(s), and/or the target UE 510 may send PRS to the anchor UE 520, that measures the received PRS and reports the measurement(s). The anchor UE 520 may send PRS 762 (e.g., DL PRS) to the target UE 510 per the PRS configuration in the PRS configuration message 754. The target UE 510 measures received PRS and sends a PRS measurement report 763 with position information (e.g., one or more corresponding measurements, one or more position estimates, one or more pseudoranges, etc.) to the TRP 531 and the TRP 531 sends a corresponding measurement report 764 to the server 400. For UE-based positioning, the anchor UE 520 may send a measurement report to the target UE 510, and the target UE 510 may not send the PRS measurement report 763. Also or alternatively, the target UE 510 sends PRS 766 (e.g., UL PRS/SRS for positioning) to the anchor UE 520. The anchor UE 520 is configured to receive and measure UL PRS. The anchor UE 520 receives and measures the (UL) PRS 766 from the target UE 510 and sends a corresponding measurement report 767 with position information to the TRP 534. The TRP 534 sends a measurement report 768, corresponding to the measurement report 767, to the server 400. Also or alternatively, the anchor UE 520 may send a measurement report 769 directly to the server 400, e.g., using a UE protocol such as LPP or using a protocol that a TRP would use, e.g., NRPPa signaling. If no measurement gap (MG) is scheduled for the anchor UE 520 to measure the PRS 766, then the anchor UE 520 may measure only the UL PRS that the anchor UE 520 receives within a receive bandwidth part (Rx BWP) of the anchor UE 520. If a measurement gap is scheduled (per the PRS configuration in the PRS configuration message 754) for the anchor UE 520, then the anchor UE 520 may measure UL PRS, from the target UE 510, outside of the Rx BWP of the anchor UE 520 (possibly all of the UL PRS), e.g., because the anchor UE 520 may be able to retune one or more receive chains as appropriate (e.g., adjusting one or more of the signal paths 910, 920 to receive desired PRS). For example, the server 400 may instruct the TRP 534 that the anchor UE 520 will be receiving UL PRS from the target UE 510, and the TRP 534 may respond to this instruction by scheduling an MG for measuring the UL PRS from the target UE 510.

Instead of or addition to reporting PRS measurement(s), the anchor UE 520 may act as a communication relay for the target UE 510. The anchor UE 520 may relay one or more communication messages from the target UE 510 to a TRP and/or to the server 400, e.g., with the anchor UE 520 acting like a TRP. The anchor UE 520 may be configured to provide more processing capability and/or faster processing speed than a typical handset in order to provide such relay services and/or UL PRS processing. For example, the anchor UE 520 may be a vehicle, a drone, a dedicated mobile robot (e.g., on a factory floor), etc.

At stages 770, 780, the location of the target UE 510 may be determined, e.g., using one or more positioning techniques (e.g., discussed above) based on one or more PRS measurements. The stages 770, 780 may be performed at different times, and one or more of the stages 770, 780 may be omitted from the flow 700. Stage 770 is for UE-based positioning and stage 780 is for UE-assisted positioning. The TRP 531 may also be configured to determine position of the target UE 510, e.g., with an LMF provided in the TRP 531.

Operation

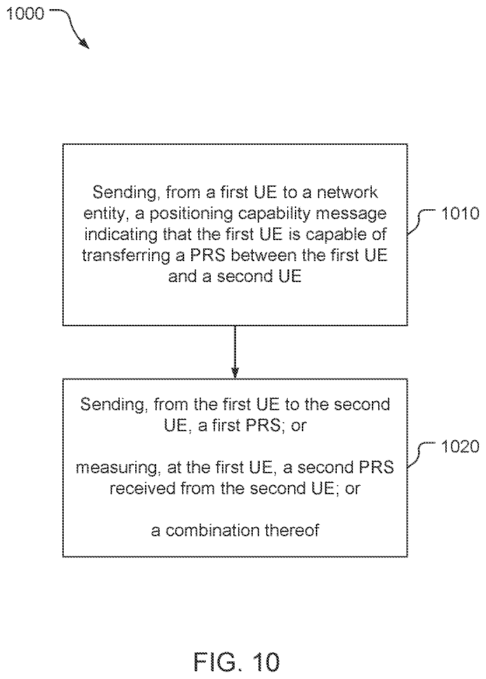

Referring to FIG. 10, with further reference to FIGS. 1-9, a method 1000 for using a first UE as an anchor point includes the stages shown. The method 1000 is, however, an example and not limiting. The method 1000 may be altered, e.g., by having stages added, removed, rearranged, combined, performed concurrently, and/or having single stages split into multiple stages.

At stage 1010, the method 1000 includes sending, from the first UE to a network entity, a positioning capability message indicating that the first UE is capable of transferring a PRS between the first UE and a second UE. For example, the anchor UE 520, e.g., the UE-UE positioning unit 650, sends the capability message 722 to the server 400 and/or the capability message 724 to the server 400 via the TRP 534. The capability message 722 may indicate that the first UE is capable of sending the first PRS to the second UE, or may indicate that the first UE is capable of measuring the second PRS from the second UE, or may indicate that the first UE is capable of sending the first PRS to the second UE and that the first UE is capable of measuring the second PRS from the second UE. The processor 610, possibly in combination with the memory 630, in combination with the wireless interface 620 (e.g., the wireless transmitter 242 and the antenna 246, and/or the wireless receiver 244 and the antenna 246) may comprise means for sending the positioning capability message.

At stage 1020, the method 1000 includes: sending, from the first UE to the second UE, a first PRS; or measuring, at the first UE, a second PRS received from the second UE; or a combination thereof. For example, the anchor UE 520 (e.g., the UE 600) may be configured to send PRS to the target UE 510 and/or to measure PRS received from the target UE 510. The anchor UE 520 may send the PRS 762 (e.g. DL PRS) to the target UE 510 and/or the anchor UE 520 may receive and measure the PRS 766 (e.g., UL PRS) from the target UE 510. The anchor UE 520, by serving as an anchor, may help enable determination of position information (e.g., a position estimate), at least with a desired accuracy, and may improve positioning accuracy. The processor 610, possibly in combination with the memory 630, in combination with the wireless interface 620 (e.g., the wireless transmitter 242 and the antenna 246, and/or the wireless receiver 244 and the antenna 246) may comprise means for sending the first PRS and/or means for measuring the second PRS.

Implementations of the method 1000 may include one or more of the following features. In an example implementation, the positioning capability message indicates that the first UE is configured to imitate a transmission/reception point (TRP) for sending the first PRS to the second UE or measuring the second PRS from the second UE or a combination thereof. For example, the capability message 722, 724 may include the mode field 810 indicating the transparent mode (e.g., to imitate a TRP for sending PRS to the target UE 510 and/or measuring PRS from the target UE 510). Providing this information may help determine how to use the anchor UE 520 to determine position information for the target UE 510. In a further example implementation, the method 1000 includes sending, to the network entity, an expected reference signal time difference, or an expected reference signal time difference uncertainty, or one or more quasi co-location parameters, or any combination thereof. For example, the anchor UE 520 may send the information in the positioning parameters field 850. The anchor UE 520 may send the expected reference signal time difference (A), or the expected reference signal time difference (B), or one or more quasi co-location parameters (C), or A and B, or A and C, or A and B and C. Providing this information may help determine how to use the anchor UE 520 to determine position information for the target UE 510, and possibly what accuracy of position information may be obtained by using the anchor UE 520 as an anchor. The processor 610, possibly in combination with the memory 630, in combination with the wireless interface 620 (e.g., the wireless transmitter 242 and the antenna 246) may comprise means for sending the expected RSTD, the RSTD uncertainty, and/or the QCL parameter(s).

Also or alternatively, implementations of the method 1000 may include one or more of the following features. In an example implementation, the positioning capability message is sent to the network entity in response to a request received from the network entity for whether the first UE is capable of serving as an anchor point for positioning of the second UE. For example, the anchor UE 520 sends the capability message 722, 724 only if the anchor UE 520 receives the anchor request 718 (or another anchor request) asking whether the anchor UE 520 (or UEs generally) are capable (e.g., able and willing) to serve as an anchor point. This may help avoid communication overhead, when the anchor UE 520 is not needed as an anchor. The second sending means may comprise means for sending the positioning capability message to the network entity in response to a request received from the network entity for whether the first UE is capable of serving as the anchor point for positioning of the second UE. In another example implementation, the method 1000 includes sending, from the first UE to the second UE: a real time difference (A), or a location of the first UE (B), or a location uncertainty of the location of the first UE (C), or a beam angle provided by the first UE (D), or a beam shape provided by the first UE (E), or a mobility status of the first UE (F), or any combination thereof (i.e., any combination of two or more of A-F, i.e., any combination of two of A-F (e.g., A and B, or A and C, etc.), or any combination of three of A-F (e.g., A and B and C, or A and B and D, etc.), or any combination of four of A-F (e.g., A and B and C and D, or A and B and C and E, etc.), or any combination of five of A-F (e.g., A and B and C and D and E, or A and C and D and E and F, etc.), or A and B and C and D and E and F). For example, the anchor UE 520 may send one or more of the fields 860, 870, 880, 890 to the target UE 510 directly or indirectly via the server 400 (and one or more TRPs). Providing this information may help determine how to use the anchor UE 520 to determine position information for the target UE 510, and possibly what accuracy of position information may be obtained by using the anchor UE 520 as an anchor. The processor 610, possibly in combination with the memory 630, in combination with the wireless interface 620 (e.g., the wireless transmitter 242 and the antenna 246) may comprise means for sending the RTD, the location, the location uncertainty, the beam angle, the beam shape, and/or the mobility state of the anchor UE 520. In another example implementation, the method 1000 includes: sending, from the first UE to the second UE, the first PRS with the first PRS comprising a first sidelink PRS; or measuring, at the first UE, the second PRS with the second PRS comprising a second sidelink PRS, or a combination thereof. For example, the anchor UE 520 may operate in the advanced mode to send or measure SL PRS. In another example implementation, the method 1000 comprises measuring, at the first UE, the second PRS, wherein the second PRS comprises an uplink PRS. For example, the anchor UE 520 may measure the PRS 766, with the PRS 766 being a UL PRS and the anchor UE 520 configured to receive and measure UL PRS. The processor 610, possibly in combination with the memory 630, in combination with the wireless interface 620 (e.g., the wireless receiver 244 and the antenna 246) may comprise means for measuring the second PRS with the second PRS comprising UL PRS. In another example implementation, the method 1000 comprises sending, from the first UE, a positioning measurement report to the network entity using a protocol used by TRPs for sending positioning measurement reports to the network entity. For example, the anchor UE 520 may send the measurement report 769 using LPP signaling (e.g., with NRPPa signaling in LPP signaling). As another example, the measurement report 767 may be sent to the TRP 534 and the TRP 534 may send the measurement report 768 to the server 400. The processor 610, possibly in combination with the memory 630, in combination with the wireless interface 620 (e.g., the wireless transmitter 242 and the antenna 246) may comprise means for sending a positioning measurement report. The measurement report (e.g., the measurement report 767, 769) may include a TRP-ID or a cell ID or a combination thereof (i.e., the TRP-ID and the cell ID), e.g., as received in the TRP-ID/cell-ID message 734. In another example implementation, the method 1000 comprises measuring the second PRS by measuring only a portion of the second PRS within a downlink bandwidth part of the first UE absent a measurement gap at the first UE during reception of the second PRS. In another example implementation, the method 1000 comprises measuring the second PRS, wherein measuring the second PRS comprises measuring all of the second PRS in response to the second PRS coinciding with a measurement gap at the first UE.

### IMPLEMENTATION EXAMPLES

Implementation examples are provided in the following numbered clauses.
Clause 1. A first UE (user equipment) comprising:
a wireless interface;
a memory; and
a processor communicatively coupled to the wireless interface and the memory; wherein the processor is configured to send, via the wireless interface to a network entity, a positioning capability message indicating that the first UE is capable of transferring a PRS (positioning reference signal) between the first UE and a second UE; and
wherein:
   the processor is configured to send, via the wireless interface to the second UE, a first PRS; or
   the processor is configured to measure a second PRS received via the wireless interface from the second UE; or
   a combination thereof.
Clause 2. The first UE of clause 1, wherein the positioning capability message further indicates that the first UE is configured to imitate a transmission/reception point (TRP) for sending the first PRS to the second UE or measuring the second PRS from the second UE or a combination thereof.
Clause 3. The first UE of clause 2, wherein the processor is further configured to send, to the network entity, an expected reference signal time difference, or an expected reference signal time difference uncertainty, or one or more quasi co-location parameters, or any combination thereof.
Clause 4. The first UE of clause 1, wherein the processor is configured to send the positioning capability message to the network entity in response to a request received from the network entity for whether the first UE is capable of serving as an anchor point for positioning of the second UE.
Clause 5. The first UE of clause 1, wherein the processor is further configured to send, to the second UE: a real time difference, or a location of the first UE, or a location uncertainty of the location of the first UE, or a beam angle provided by the first UE, or a beam shape provided by the first UE, or a mobility status of the first UE, or any combination thereof.
Clause 6. The first UE of clause 1, wherein:
the processor is configured to send the first PRS with the first PRS comprising a first sidelink PRS; or
the processor is configured to measure the second PRS with the second PRS comprising a second sidelink PRS; or
a combination thereof.
Clause 7. The first UE of clause 1, wherein the wireless interface and the processor are further configured to receive and measure the second PRS, the second PRS comprising an uplink PRS.
Clause 8. The first UE of clause 1, wherein the processor is further configured to send a positioning measurement report to the network entity via the wireless interface using a protocol used by transmission/reception points for sending positioning measurement reports to the network entity.
Clause 9. The first UE of clause 8, wherein the processor is further configured to send a TRP ID (transmission/reception point identity) or a cell ID, or a combination thereof, to the second UE in the positioning measurement report.
Clause 10. The first UE of clause 1, wherein the processor is configured to process, absent a measurement gap at the first UE during reception of the second PRS, only a portion of the second PRS within a downlink bandwidth part of the first UE.
Clause 11. The first UE of clause 1, wherein the processor is configured to process, in response to the second PRS coinciding with a measurement gap at the first UE, all of the second PRS.
Clause 12. A method for using a first UE (user equipment) as an anchor point, the method comprising:
sending, from the first UE to a network entity, a positioning capability message indicating that the first UE is capable of transferring a PRS (positioning reference signal) between the first UE and a second UE;
wherein the method further comprises:
   sending, from the first UE to the second UE, a first PRS; or
   measuring, at the first UE, a second PRS received from the second UE; or
   a combination thereof.
Clause 13. The method of clause 12, wherein the positioning capability message indicates that the first UE is configured to imitate a transmission/reception point (TRP) for sending the first PRS to the second UE or measuring the second PRS from the second UE or a combination thereof.
Clause 14. The method of clause 13, further comprising sending, to the network entity, an expected reference signal time difference, or an expected reference signal time difference uncertainty, or one or more quasi co-location parameters, or any combination thereof.
Clause 15. The method of clause 12, wherein the positioning capability message is sent to the network entity in response to a request received from the network entity for whether the first UE is capable of serving as the anchor point for positioning of the second UE.
Clause 16. The method of clause 12, further comprising sending, from the first UE to the second UE: a real time difference, or a location of the first UE, or a location uncertainty of the location of the first UE, or a beam angle provided by the first UE, or a beam shape provided by the first UE, or a mobility status of the first UE, or any combination thereof.
Clause 17. The method of clause 12, comprising:
sending, from the first UE to the second UE, the first PRS with the first PRS comprising a first sidelink PRS; or
measuring, at the first UE, the second PRS with the second PRS comprising a second sidelink PRS; or
a combination thereof.
Clause 18. The method of clause 12, comprising measuring, at the first UE, the second PRS, wherein the second PRS comprises an uplink PRS.
Clause 19. The method of clause 12, further comprising sending, from the first UE, a positioning measurement report to the network entity using a protocol used by transmission/reception points for sending positioning measurement reports to the network entity.
Clause 20. The method of clause 19, wherein the positioning measurement report includes a TRP ID (transmission/reception point identity) or a cell ID or a combination thereof.
Clause 21. The method of clause 12, comprising measuring the second PRS, wherein measuring the second PRS comprises measuring only a portion of the second PRS within a downlink bandwidth part of the first UE absent a measurement gap at the first UE during reception of the second PRS.
Clause 22. The method of clause 12, comprising measuring the second PRS, wherein measuring the second PRS comprises measuring all of the second PRS in response to the second PRS coinciding with a measurement gap at the first UE.
Clause 23. A first UE (user equipment) comprising:
second sending means for sending, to a network entity, a positioning capability message indicating that the first UE is capable of transferring a PRS (positioning reference signal) between the first UE and a second UE; and
wherein the first UE further comprises:
   first sending means for sending, to the second UE, a first PRS; or
   means for measuring a second PRS received from the second UE; or
   a combination thereof.
Clause 24. The first UE of clause 23, wherein the positioning capability message indicates that the first UE is configured to imitate a transmission/reception point (TRP) for sending the first PRS to the second UE or measuring the second PRS from the second UE or a combination thereof.
Clause 25. The first UE of clause 24, wherein the second sending means comprises means for sending, to the network entity, an expected reference signal time difference, or an expected reference signal time difference uncertainty, or one or more quasi co-location parameters, or any combination thereof.
Clause 26. The first UE of clause 23, wherein the second sending means comprises means for sending the positioning capability message to the network entity in response to a request received from the network entity for whether the first UE is capable of serving as an anchor point for positioning of the second UE.
Clause 27. The first UE of clause 23, further comprising third sending means for sending, to the second UE: a real time difference, or a location of the first UE, or a location uncertainty of the location of the first UE, or a beam angle provided by the first UE, or a beam shape provided by the first UE, or a mobility status of the first UE, or any combination thereof.
Clause 28. The first UE of clause 23, wherein:
the first UE comprises the first sending means, wherein the first PRS comprises a first sidelink PRS; or
the first UE comprises the means for measuring the second PRS, wherein the second PRS comprises a second sidelink PRS; or
a combination thereof.
Clause 29. The first UE of clause 23, comprising the means for measuring the second PRS, wherein the second PRS comprises an uplink PRS.
Clause 30. The first UE of clause 23, further comprising means for sending a positioning measurement report to the network entity using a protocol used by transmission/reception points for sending positioning measurement reports to the network entity.
Clause 31. The first UE of clause 30, wherein the positioning measurement report includes a TRP ID (transmission/reception point identity) or a cell ID or a combination thereof.
Clause 32. The first UE of clause 23, comprising the means for measuring the second PRS, wherein the means for measuring the second PRS comprises means for measuring only a portion of the second PRS within a downlink bandwidth part of the first UE absent a measurement gap at the first UE during reception of the second PRS.
Clause 33. The first UE of clause 23, comprising the means for measuring the second PRS, wherein the means for measuring the second PRS comprises means for measuring all of the second PRS in response to the second PRS coinciding with a measurement gap at the first UE.
Clause 34. A non-transitory, processor-readable storage medium comprising processor-readable instructions to cause a processor, of a first UE (user equipment), to:
send, to a network entity, a positioning capability message indicating that the first UE is capable of transferring a PRS (positioning reference signal) between the first UE and a second UE;
wherein the non-transitory, processor-readable storage medium further comprises:
   processor-readable instructions to cause the processor to send, to the second UE, a first PRS; or
   processor-readable instructions to cause the processor to measure a second PRS received from the second UE; or
   a combination thereof.
Clause 35. The non-transitory, processor-readable storage medium of clause 34, wherein the positioning capability message indicates that the first UE is configured to imitate a transmission/reception point (TRP) for sending the first PRS to the second UE or measuring the second PRS from the second UE or a combination thereof.
Clause 36. The non-transitory, processor-readable storage medium of clause 35, further comprising processor-readable instructions to cause the processor to send, to the network entity, an expected reference signal time difference, or an expected reference signal time difference uncertainty, or one or more quasi co-location parameters, or any combination thereof.
Clause 37. The non-transitory, processor-readable storage medium of clause 34, wherein the processor-readable instructions to cause the processor to send the positioning capability message comprise processor-readable instructions to cause the processor to send the positioning capability message to the network entity in response to a request received from the network entity for whether the first UE is capable of serving as the anchor point for positioning of the second UE.
Clause 38. The non-transitory, processor-readable storage medium of clause 34, further comprising processor-readable instructions to cause the processor to send, to the second UE: a real time difference, or a location of the first UE, or a location uncertainty of the location of the first UE, or a beam angle provided by the first UE, or a beam shape provided by the first UE, or a mobility status of the first UE, or any combination thereof.
Clause 39. The non-transitory, processor-readable storage medium of clause 34, comprising:
the processor-readable instructions to cause the processor to send the first PRS, wherein the first PRS comprises a first sidelink PRS; or
the processor-readable instructions to cause the processor to measure the second PRS, wherein the second PRS comprises a second sidelink PRS; or
a combination thereof.
Clause 40. The non-transitory, processor-readable storage medium of clause 34, comprising the processor-readable instructions to cause the processor to measure the second PRS, wherein the second PRS comprises an uplink PRS.
Clause 41. The non-transitory, processor-readable storage medium of clause 34, further comprising processor-readable instructions to cause the processor to send a positioning measurement report to the network entity using a protocol used by transmission/reception points for sending positioning measurement reports to the network entity.
Clause 42. The non-transitory, processor-readable storage medium of clause 41, wherein the positioning measurement report includes a TRP ID (transmission/reception point identity) or a cell ID or a combination thereof.
Clause 43. The non-transitory, processor-readable storage medium of clause 34, comprising the processor-readable instructions to cause the processor to measure the second PRS, wherein the processor-readable instructions to cause the processor to measure the second PRS comprise processor-readable instructions to cause the processor to measure only a portion of the second PRS within a downlink bandwidth part of the first UE absent a measurement gap at the first UE during reception of the second PRS.
Clause 44. The non-transitory, processor-readable storage medium of clause 34, comprising the processor-readable instructions to cause the processor to measure the second PRS, wherein the processor-readable instructions to cause the processor to measure the second PRS comprise processor-readable instructions to cause the processor to measure all of the second PRS in response to the second PRS coinciding with a measurement gap at the first UE.

Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A first UE (user equipment) comprising:
a wireless interface;
a memory; and
a processor communicatively coupled to the wireless interface and the memory;
wherein the processor is configured to send, via the wireless interface to a network entity, a positioning capability message indicating that the first UE is capable of transferring a PRS (positioning reference signal) between the first UE and a second UE; and
wherein:
the processor is configured to send, via the wireless interface to the second UE, a first PRS; or
the processor is configured to measure a second PRS received via the wireless interface from the second UE; or
a combination thereof.

2. The first UE of claim 1, wherein the positioning capability message further indicates that the first UE is configured to imitate a transmission/reception point (TRP) for sending the first PRS to the second UE or measuring the second PRS from the second UE or a combination thereof.

3. The first UE of claim 2, wherein the processor is further configured to send, to the network entity, an expected reference signal time difference, or an expected reference signal time difference uncertainty, or one or more quasi co-location parameters, or any combination thereof.

4. The first UE of claim 1, wherein the processor is configured to send the positioning capability message to the network entity in response to a request received from the network entity for whether the first UE is capable of serving as an anchor point for positioning of the second UE.

5. The first UE of claim 1, wherein the processor is further configured to send, to the second UE: a real time difference, or a location of the first UE, or a location uncertainty of the location of the first UE, or a beam angle provided by the first UE, or a beam shape provided by the first UE, or a mobility status of the first UE, or any combination thereof.

6. The first UE of claim 1, wherein:
the processor is configured to send the first PRS with the first PRS comprising a first sidelink PRS; or
the processor is configured to measure the second PRS with the second PRS comprising a second sidelink PRS; or
a combination thereof.

7. The first UE of claim 1, wherein the wireless interface and the processor are further configured to receive and measure the second PRS, the second PRS comprising an uplink PRS.

8. The first UE of claim 1, wherein the processor is further configured to send a positioning measurement report to the network entity via the wireless interface using a protocol used by transmission/reception points for sending positioning measurement reports to the network entity.

9. The first UE of claim 8, wherein the processor is further configured to send a TRP ID (transmission/reception point identity) or a cell ID, or a combination thereof, to the second UE in the positioning measurement report.

10. The first UE of claim 1, wherein the processor is configured to process, absent a measurement gap at the first UE during reception of the second PRS, only a portion of the second PRS within a downlink bandwidth part of the first UE.

11. The first UE of claim 1, wherein the processor is configured to process, in response to the second PRS coinciding with a measurement gap at the first UE, all of the second PRS.

12. A method for using a first UE (user equipment) as an anchor point, the method comprising:
sending, from the first UE to a network entity, a positioning capability message indicating that the first UE is capable of transferring a PRS (positioning reference signal) between the first UE and a second UE;
wherein the method further comprises:
sending, from the first UE to the second UE, a first PRS; or
measuring, at the first UE, a second PRS received from the second UE; or
a combination thereof.

13. The method of claim 12, wherein the positioning capability message indicates that the first UE is configured to imitate a transmission/reception point (TRP) for sending the first PRS to the second UE or measuring the second PRS from the second UE or a combination thereof.

14. The method of claim 13, further comprising sending, to the network entity, an expected reference signal time difference, or an expected reference signal time difference uncertainty, or one or more quasi co-location parameters, or any combination thereof.

15. The method of claim 12, wherein the positioning capability message is sent to the network entity in response to a request received from the network entity for whether the first UE is capable of serving as the anchor point for positioning of the second UE.

16. The method of claim 12, further comprising sending, from the first UE to the second UE: a real time difference, or a location of the first UE, or a location uncertainty of the location of the first UE, or a beam angle provided by the first UE, or a beam shape provided by the first UE, or a mobility status of the first UE, or any combination thereof.

17. The method of claim 12, comprising:
sending, from the first UE to the second UE, the first PRS with the first PRS comprising a first sidelink PRS; or
measuring, at the first UE, the second PRS with the second PRS comprising a second sidelink PRS; or
a combination thereof.

18. The method of claim 12, comprising measuring, at the first UE, the second PRS, wherein the second PRS comprises an uplink PRS.

19. The method of claim 12, further comprising sending, from the first UE, a positioning measurement report to the network entity using a protocol used by transmission/reception points for sending positioning measurement reports to the network entity.

20. The method of claim 19, wherein the positioning measurement report includes a TRP ID (transmission/reception point identity) or a cell ID or a combination thereof.

21. The method of claim 12, comprising measuring the second PRS, wherein measuring the second PRS comprises measuring only a portion of the second PRS within a downlink bandwidth part of the first UE absent a measurement gap at the first UE during reception of the second PRS.

22. The method of claim 12, comprising measuring the second PRS, wherein measuring the second PRS comprises measuring all of the second PRS in response to the second PRS coinciding with a measurement gap at the first UE.

23. A first UE (user equipment) comprising:
second sending means for sending, to a network entity, a positioning capability message indicating that the first UE is capable of transferring a PRS (positioning reference signal) between the first UE and a second UE; and
wherein the first UE further comprises:
first sending means for sending, to the second UE, a first PRS; or
means for measuring a second PRS received from the second UE; or
a combination thereof.

24. The first UE of claim 23, wherein the positioning capability message indicates that the first UE is configured to imitate a transmission/reception point (TRP) for sending the first PRS to the second UE or measuring the second PRS from the second UE or a combination thereof.

25. The first UE of claim 24, wherein the second sending means comprises means for sending, to the network entity, an expected reference signal time difference, or an expected reference signal time difference uncertainty, or one or more quasi co-location parameters, or any combination thereof.

26. The first UE of claim 23, wherein the second sending means comprises means for sending the positioning capability message to the network entity in response to a request received from the network entity for whether the first UE is capable of serving as an anchor point for positioning of the second UE.

27. The first UE of claim 23, further comprising third sending means for sending, to the second UE: a real time difference, or a location of the first UE, or a location uncertainty of the location of the first UE, or a beam angle provided by the first UE, or a beam shape provided by the first UE, or a mobility status of the first UE, or any combination thereof.

28. The first UE of claim 23, wherein:
the first UE comprises the first sending means, wherein the first PRS comprises a first sidelink PRS; or
the first UE comprises the means for measuring the second PRS, wherein the second PRS comprises a second sidelink PRS; or
a combination thereof.

29. The first UE of claim 23, comprising the means for measuring the second PRS, wherein the second PRS comprises an uplink PRS.

30. The first UE of claim 23, further comprising means for sending a positioning measurement report to the network entity using a protocol used by transmission/reception points for sending positioning measurement reports to the network entity.

31. The first UE of claim 30, wherein the positioning measurement report includes a TRP ID (transmission/reception point identity) or a cell ID or a combination thereof.

32. The first UE of claim 23, comprising the means for measuring the second PRS, wherein the means for measuring the second PRS comprises means for measuring only a portion of the second PRS within a downlink bandwidth part of the first UE absent a measurement gap at the first UE during reception of the second PRS.

33. The first UE of claim 23, comprising the means for measuring the second PRS, wherein the means for measuring the second PRS comprises means for measuring all of the second PRS in response to the second PRS coinciding with a measurement gap at the first UE.

34. A non-transitory, processor-readable storage medium comprising processor-readable instructions to cause a processor, of a first UE (user equipment), to:
send, to a network entity, a positioning capability message indicating that the first UE is capable of transferring a PRS (positioning reference signal) between the first UE and a second UE;
wherein the non-transitory, processor-readable storage medium further comprises:
processor-readable instructions to cause the processor to send, to the second UE, a first PRS; or
processor-readable instructions to cause the processor to measure a second PRS received from the second UE; or
a combination thereof.

35. The non-transitory, processor-readable storage medium of claim 34, wherein the positioning capability message indicates that the first UE is configured to imitate a transmission/reception point (TRP) for sending the first PRS to the second UE or measuring the second PRS from the second UE or a combination thereof.
